(19) United States
(12) Patent Application Publication
(10) Pub. No.: US 2026/0238794 A1
(43) Pub. Date: Aug. 13, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 19/638,912

(22) Filed: Apr. 3, 2026

Related U.S. Application Data
(63) Continuation of application No. PCT/CN2024/123114, filed on Sep. 30, 2024.

(30) Foreign Application Priority Data
Oct. 4, 2023 (WO) PCT/CN2023/123096

(51) Int. Cl. H04N 19/136; H04N 19/176

(52) U.S. Cl. CPC H04N 19/136; H04N 19/176

(57) ABSTRACT

Embodiments of the present disclosure provide a solution for video processing. A method for video processing is proposed. In the method, for a conversion between a current video block of a video and a bitstream of the video, affine information of the current video block is determined based on first affine information of a first block of the video. The first block is coded with a first coding tool different from an affine coding tool. A prediction of the current video block is determined based on the affine information. The conversion is performed based on the prediction.

### CROSS-REFERENCE TO RELATED APPLICATIONS

This application is a continuation of International Application No. PCT/CN2024/123114, filed on Sep. 30, 2024, which claims the benefit of International Application No. PCT/CN2023/123096 filed on Oct. 4, 2023. The entire contents of these applications are hereby incorporated by reference in their entireties.

### FIELD

Embodiments of the present disclosure relates generally to video processing techniques, and more particularly, to subblock-based combined inter and intra prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, affine information of the current video block based on first affine information of a first block of the video, the first block being coded with a first coding tool different from an affine coding tool; determining a prediction of the current video block based on the affine information; and perform the conversion based on the prediction. The method in accordance with the first aspect of the present disclosure enables generating a prediction with affine information of a block being coded with a coding tool different from an affine coding tool.

In a second aspect, another method for video processing is proposed. The method comprises: coding, for a conversion between a current video block of a video and a bitstream of the video, a syntax element related to a combined inter and intra prediction (CIIP) based on more than one context; and performing the conversion based on the syntax element. The method in accordance with the second aspect of the present disclosure enables coding a syntax element related to a CIIP with at least one context.

In a third aspect, an apparatus for video processing is proposed. The apparatus comprises a processor and a non-transitory memory with instructions thereon. The instructions upon execution by the processor, cause the processor to perform a method in accordance with the first, or second aspect of the present disclosure.

In a fourth aspect, a non-transitory computer-readable storage medium is proposed. The non-transitory computer-readable storage medium stores instructions that cause a processor to perform a method in accordance with the first, or second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining affine information of the current video block based on first affine information of a first block of the video, the first block being coded with a first coding tool different from an affine coding tool; determining a prediction of the current video block based on the affine information; and generating the bitstream based on the prediction.

In a sixth aspect, another non-transitory computer-readable recording medium is proposed. The non-transitory computer-readable recording medium stores a bitstream of a video which is generated by a method performed by an apparatus for video processing. The method comprises: coding a syntax element related to a combined inter and intra prediction (CIIP) based on more than one context; and generating the bitstream based on the syntax element.

In a seventh aspect, a method for storing a bitstream of a video is proposed. The method comprises: determining affine information of the current video block based on first affine information of a first block of the video, the first block being coded with a first coding tool different from an affine coding tool; determining a prediction of the current video block based on the affine information; generating the bitstream based on the prediction; and storing the bitstream in a non-transitory computer-readable recording medium.

In an eighth aspect, a method for storing a bitstream of a video is proposed. The method comprises: coding a syntax element related to a combined inter and intra prediction (CIIP) based on more than one context; generating the bitstream based on the syntax element; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6 illustrates control point based affine motion model;

FIG. 7 illustrates an example affine MVF per subblock;

FIG. 8 illustrates locations of inherited affine motion predictors;

FIG. 9 illustrates control point motion vector inheritance;

FIG. 10 illustrates locations of Candidates position for constructed affine merge mode;

FIG. 11 illustrates spatial neighbors for deriving affine merge candidates;

FIG. 12 illustrates from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performs on a search area around initial MV;

FIG. 16 illustrates template and the corresponding reference template;

FIG. 17 illustrates template and reference template for block with sub-block motion using the motion information of the subblocks of current block;

FIG. 18 illustrates deriving sub-CU motion field obtained by applying a motion shift based on the neighboring motion information;

FIG. 19 illustrates top and left neighboring blocks used in CIIP weight derivation;

FIG. 20 illustrates CIIP_PDPC flowchart of the extended CIIP mode using PDPC;

FIG. 21 illustrates the division method for angular modes;

FIG. 22 illustrates subblock templates generation of SbTMVP;

FIG. 23 illustrates a diamond region in the search area;

FIG. 24 illustrates a flowchart of a method for video processing in accordance with embodiments of the present disclosure;

FIG. 25 illustrates a flowchart of another method for video processing in accordance with embodiments of the present disclosure; and

FIG. 26 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

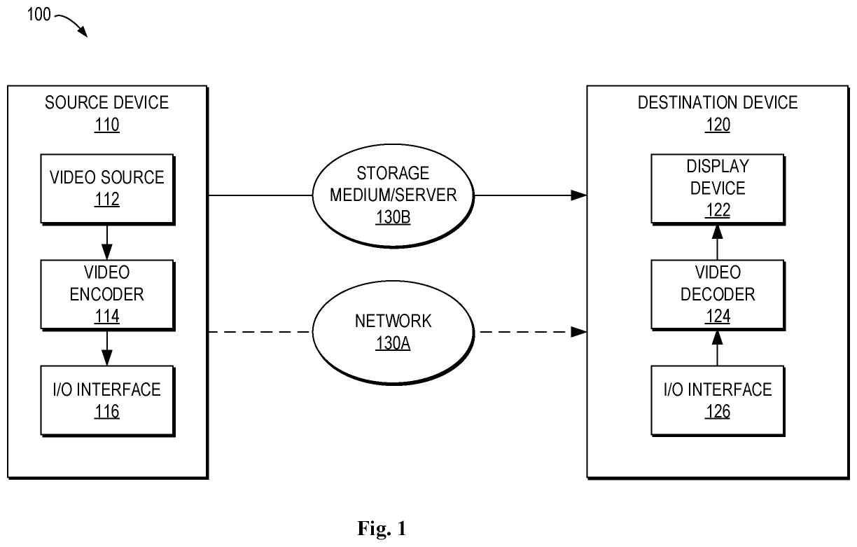

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

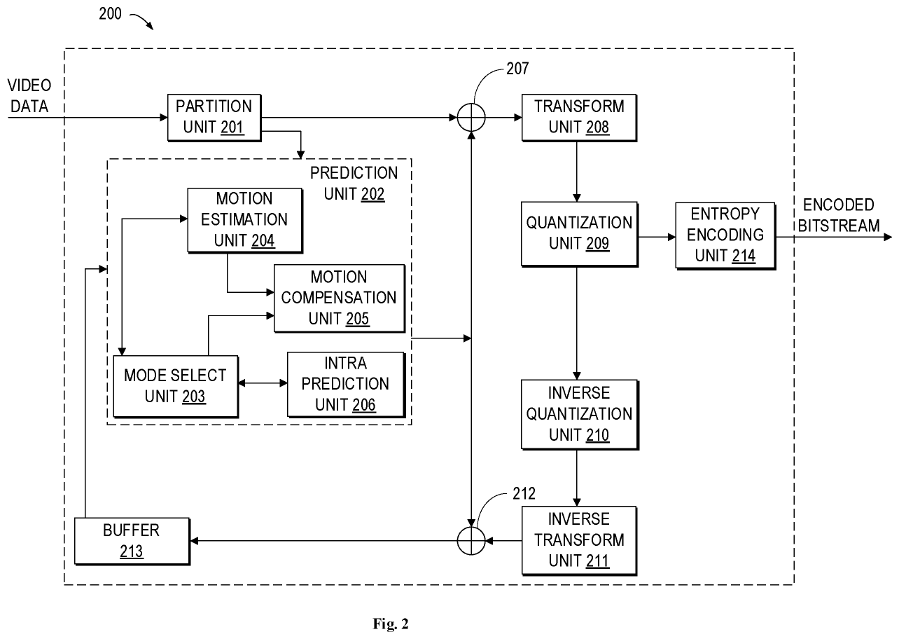

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different function al components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

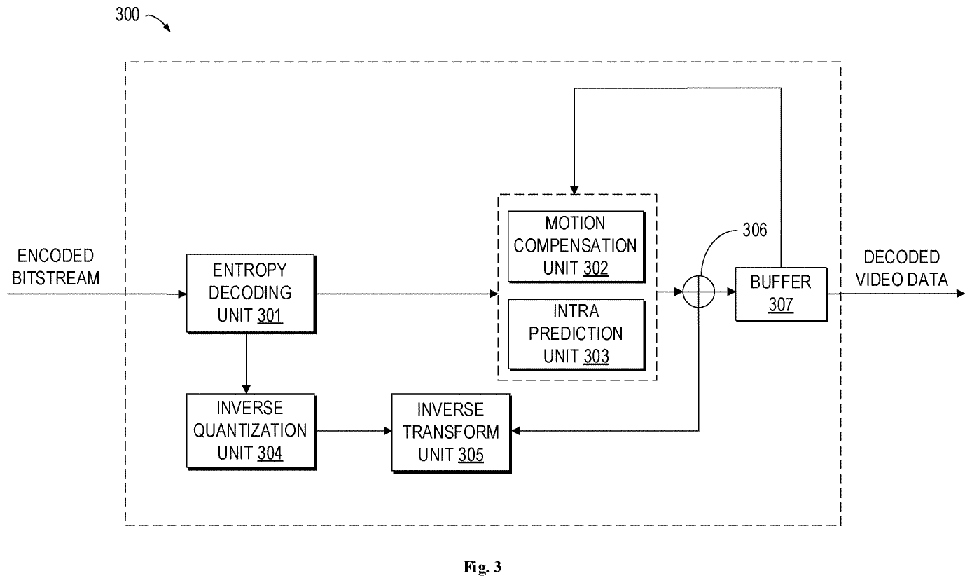

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about combined prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

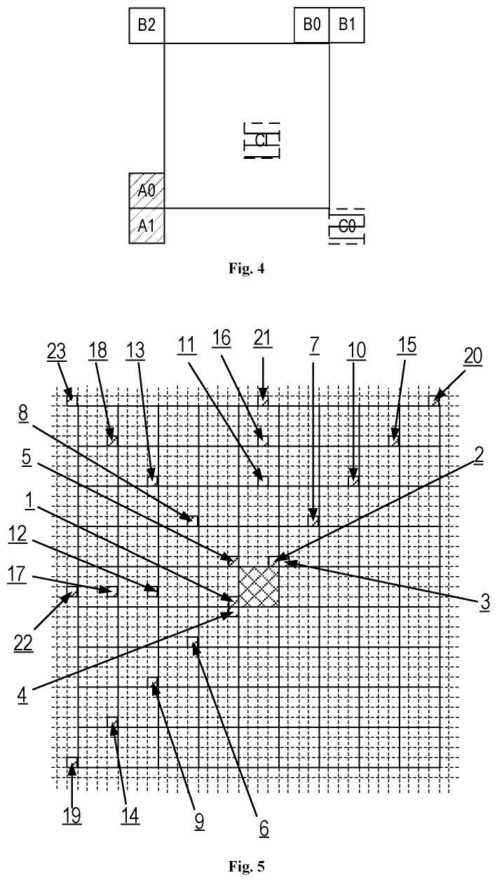

FIG. 4 illustrates positions of spatial and temporal neighboring blocks used in AMVP/merge candidate list construction.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

FIG. 5 illustrates positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5.

### 2.2. Affine Motion Compensated Prediction

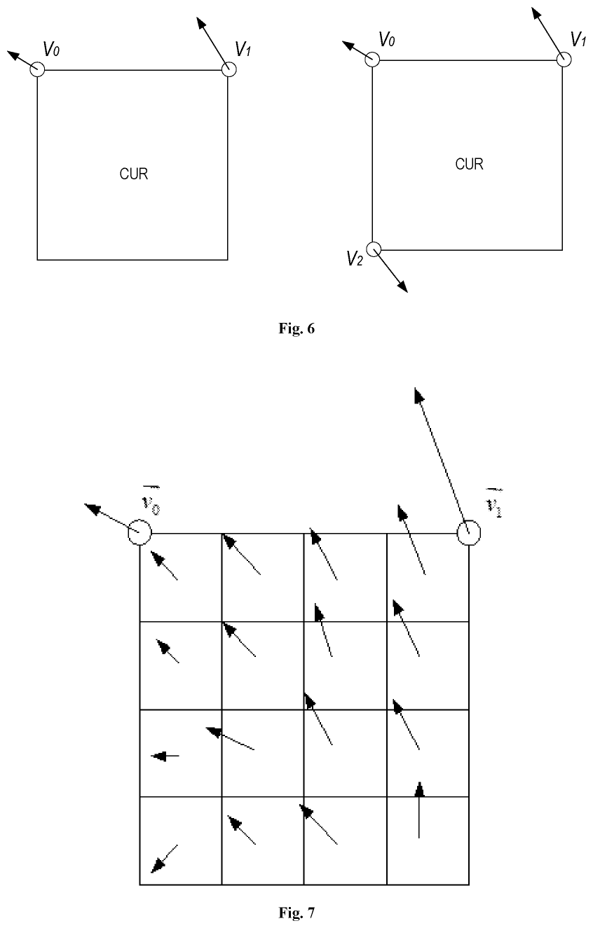

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. As shown FIG. 6, the affine motion field of the block is described by motion information of two control point (4-parameter) or three control point motion vectors (6-parameter).

FIG. 6 illustrates control point based affine motion model, including (a) 4 parameter affine model, and (b) 6 parameter affine model.

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} . \qquad ( 1 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point. To simplify the motion compensation prediction, block based affine transform prediction is applied. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

FIG. 7 illustrates affine MVF per subblock.

As done for translational motion inter prediction, there are also two affine motions inter prediction modes: affine merge mode and affine AMVP mode.

### 2.2.1. Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. In VVC, the following three types of CPVM candidate are used to form the affine merge candidate list:
Inherited affine merge candidates that extrapolated from the CPMVs of the neighbor Cus.
Constructed affine merge candidates CPMVPs that are derived using the translational MVs of the neighbor Cus.
Zero MVs

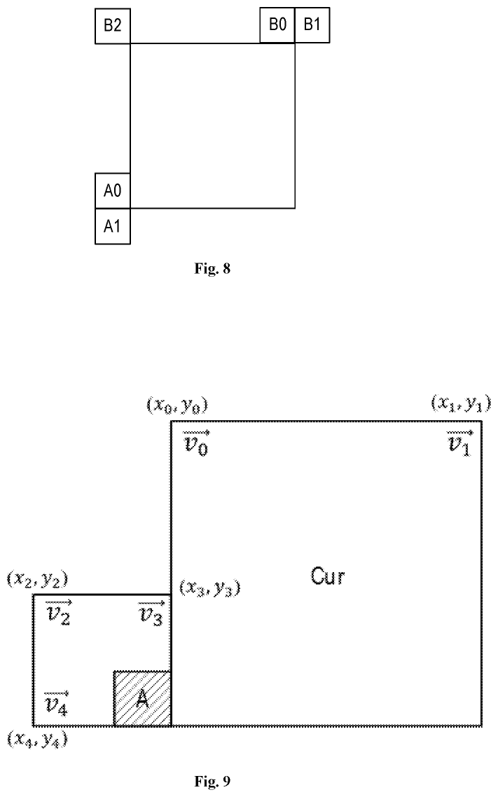

In VVC, there are maximum two inherited affine candidates, which are derived from affine motion model of the neighboring blocks, one from left neighboring CUs and one from above neighboring CUs. The candidate blocks are shown in FIG. 8. For the left predictor, the scan order is A0→A1, and for the above predictor, the scan order is B0→B1→B2. Only the first inherited candidate from each side is selected. No pruning check is performed between two inherited candidates. When a neighboring affine CU is identified, its control point motion vectors are used to derive the CPMVP candidate in the affine merge list of the current CU. As shown in FIG. 9, if the neighbor left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

FIG. 8 illustrates locations of inherited affine motion predictors.

FIG. 9 illustrates control point motion vector inheritance.

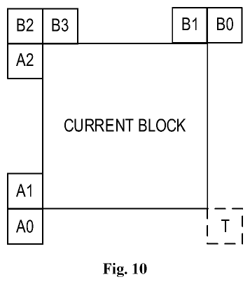

Constructed affine candidate means the candidate is constructed by combining the neighbor translational motion information of each control point. The motion information for the control points is derived from the specified spatial neighbors and temporal neighbor shown in FIG. 10. CPMVk (k=1, 2, 3, 4) represents the k-th control point. For CPMV1, the B2→B3→A2 blocks are checked and the MV of the first available block is used. For CPMV2, the B1→B0 blocks are checked and for CPMV3, the A1→A0 blocks are checked. For TMVP is used as CPMV4 if it's available.

After MVs of four control points are attained, affine merge candidates are constructed based on those motion information. The following combinations of control point MVs are used to construct in order: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

FIG. 10 illustrates locations of Candidates position for constructed affine merge mode.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and it is generated by using the following four types of CPVM candidate in order:
Inherited affine AMVP candidates that extrapolated from the CPMVs of the neighbor CUs.
Constructed affine AMVP candidates CPMVPs that are derived using the translational MVs of the neighbor CUs.
Translational MVs from neighboring CUs.
Zero MVs.

The checking order of inherited affine AMVP candidates is same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the specified spatial neighbors shown in The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

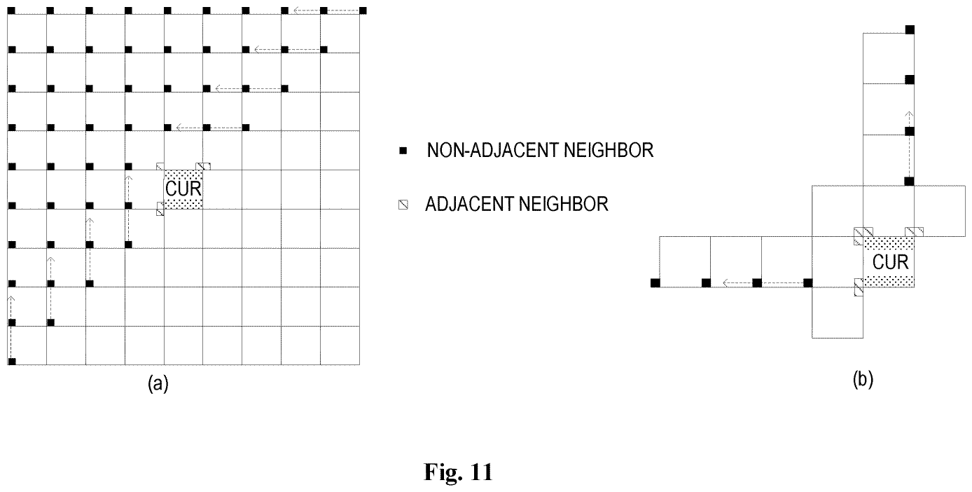

FIG. 11 illustrates spatial neighbors for deriving affine merge candidates: (a) for deriving inherited affine merge candidates (b) for deriving constructed affine merge candidates.

If affine AMVP list candidates are still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods

In ECM-6.0, 3 additional Affine merge and AMVP candidate derivation methods are integrated, which are Non-adjacent spatial candidates, History-parameter-based candidates, Regression based affine candidates and Pixel based affine motion compensation.

### 2.2.3.1. Non-Adjacent Spatial Candidates

In ECM-6.0, non-adjacent spatial neighbors are investigated to provided candidates for both Affine merge and Affine AMVP. The pattern of obtaining non-adjacent spatial candidates is shown in FIG. 11. Same as the non-adjacent regular merge candidates, the distances between non-adjacent spatial candidates and current coding block are also defined based on the width and height of current CU.

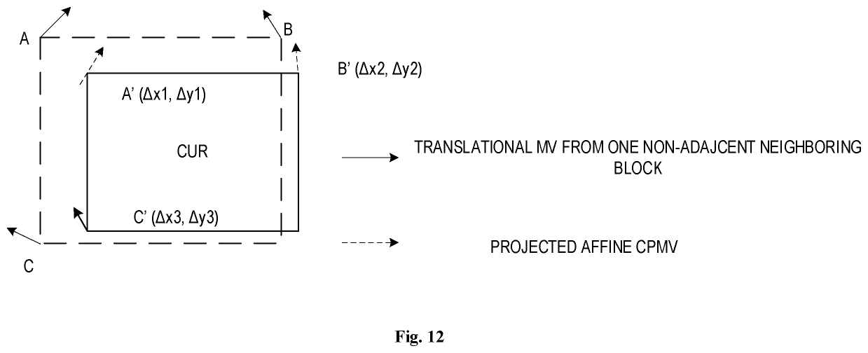

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12. FIG. 12 illustrates from non-adjacent neighbors to constructed affine merge candidates.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) \qquad ( 3 )$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat (RefListcur, RefIdxcur) in a way similar to HMVP table updating.

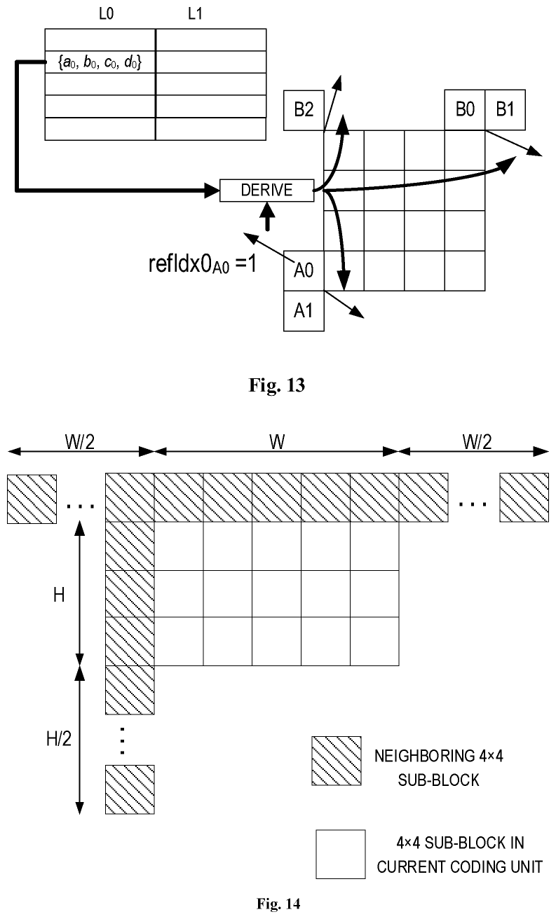

A history-affine-parameter-based candidate (HAPC) is derived from a neighbouring 4×4 block denoted as A0, A1, B0, B1 or B2 in FIG. 13 and a set of affine parameters stored in a corresponding entry in HPT. The MV of a neighbouring 4×4 block served as the base MV. In a formulating way, the MV of the current block at position (x, y) is calculated as:

$$\{ \begin{matrix}m {v}^{h} ( x , y ) = a ( x - {x}_{base} ) + c ( y - {y}_{base} ) + m {v}_{base}^{h} \\ m {v}^{v} ( x , y ) = b ( x - {x}_{base} ) + d ( y - {y}_{base} ) + m {v}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows an example of how to derive an HAPC from block A0. The affine parameters {a0, b0, co, d0} are directly fetched from one entry of category HPTIdx (RefListA0, refIdx0A0) in HPT. The affine parameters from HPT, with the center position of A0 as the base position, and the MV of block A0 as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

FIG. 13 illustrates an example of generating an HAPC.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

FIG. 14 illustrates an illustration of regression based affine merge candidate derivation.

### 2.2.3.4. Pixel Based Affine Motion Compensation

With pixel based affine motion compensation, minimum affine subblock size is set to 1×1 for luma component when OBMC is not applied, minimum subblock size is always set to 1×1 for chroma components.

### 2.3. Template Matching Merge/AMVP Mode in ECM

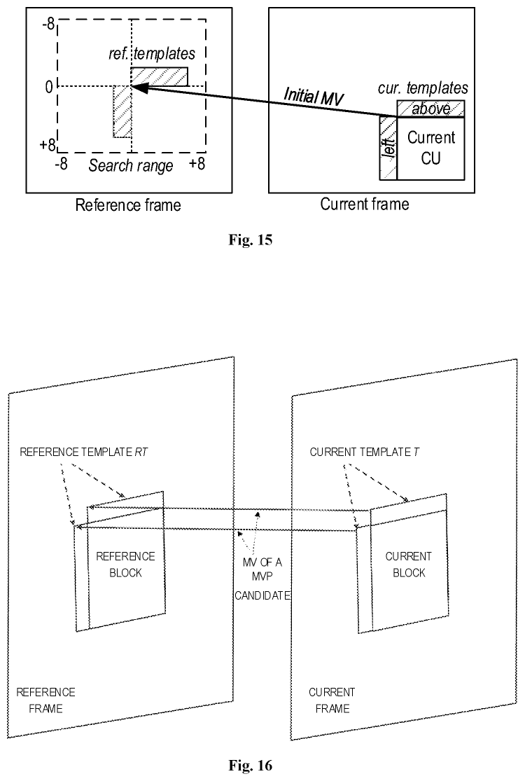

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. As illustrated in FIG. 15, a better MV is to be searched around the initial motion of the current CU within a [−8, +8]-pel search range.

FIG. 15 illustrates template matching performs on a search area around initial MV.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered. The template matching cost is measured by the sum of absolute differences (SAD) between samples of a template of the current block and their corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction. FIG. 16 illustrates template and the corresponding reference template.

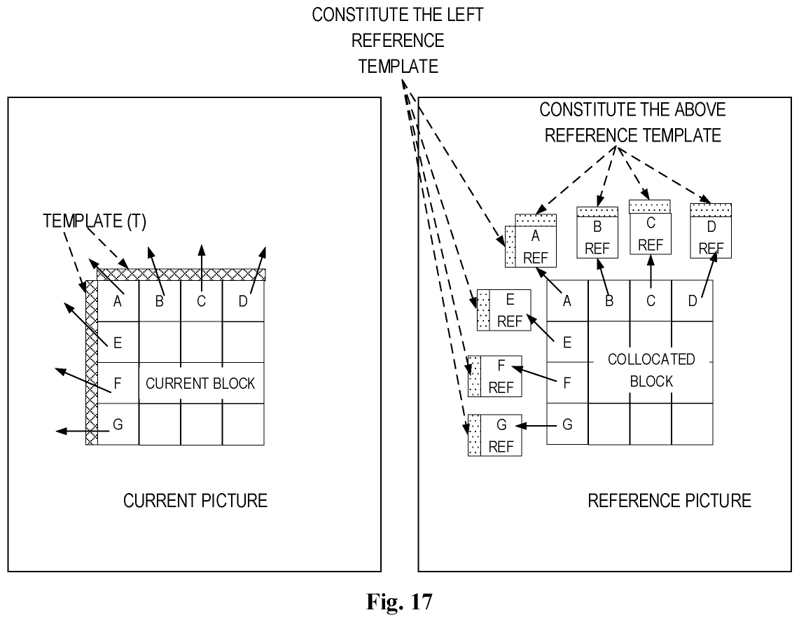

For subblock-based merge candidates with subblock size equal to Wsub*Hsub, the above template comprises several sub-templates with the size of Wsub×K, and the left template comprises several sub-templates with the size of K×Hsub. As shown in FIG. 17. the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTMVP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

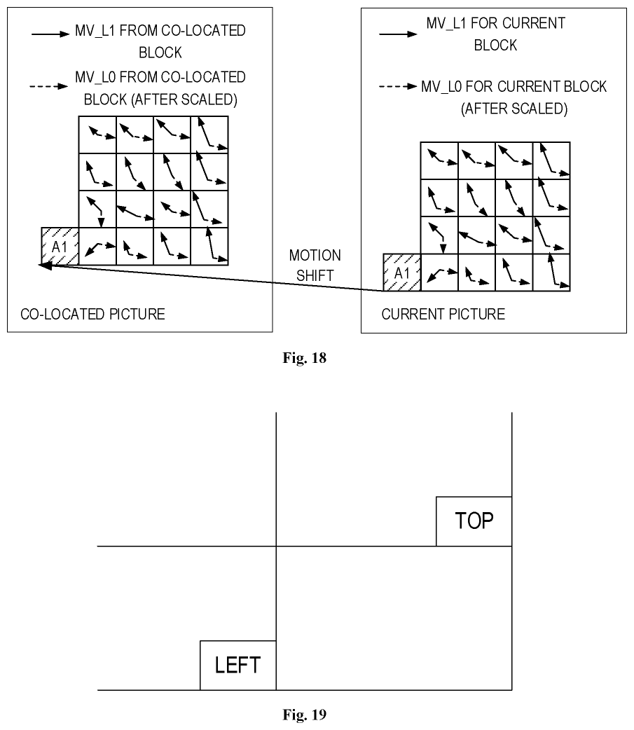

FIG. 18 illustrates the derivation process of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero mv will be used as motion shift.

Once the motion shift is determined, the specified region in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

FIG. 17 illustrates template and reference template for block with sub-block motion using the motion information of the subblocks of current block.

FIG. 18 illustrates deriving sub-CU motion field obtained by applying a motion shift based on the neighboring motion information.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.6. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 19) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + w t * {P}_{intra} + 2 ) >> 2. \qquad ( 3 - 1 )$$

FIG. 19 illustrates top and left neighboring blocks used in CIIP weight derivation.

2.7. CIIP with PDPC Blending

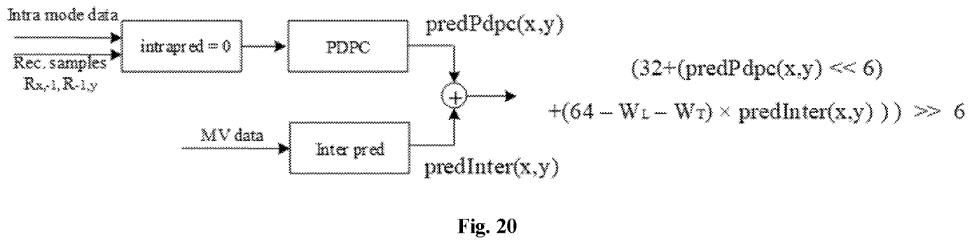

In ECM, the CIIP mode is extended. In this extended mode (CIIP_PDPC), the prediction of the regular merge mode is refined using the above (Rx, −1) and left (R−1, y) reconstructed samples. This refinement inherits the position dependent prediction combination (PDPC) scheme. The flowchart of the prediction of the CIIP_PDPC mode can be depicted as in FIG. 20, where WT and WL are the weighted values which depend on the sample position in the block as defined in PDPC.

The CIIP_PDPC mode is signaled together with CIIP mode. When CIIP flag is true, another flag, namely CIIP_PDPC flag, is further signaled to indicate whether to use CIIP_PDPC.

FIG. 20 illustrates CIIP_PDPC flowchart of the extended CIIP mode using PDPC.

2.8. Combination of CIIP with TIMD and TM Merge

In ECM CIIP mode, the prediction samples may be generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes

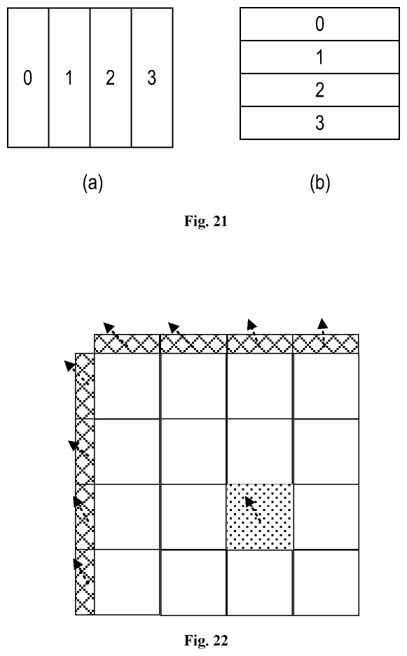

In addition, it is also proposed to modify the weights (wIntra, wInter) for the two tests if the derived intra prediction mode is an angular mode. For near-horizontal modes (2<=angular mode index <34), the current block is vertically divided as shown in (a) of FIG. 21; for near-vertical modes (34<=angular mode index <=66), the current block is horizontally divided as shown in (b) of FIG. 21.

The (wIntra, wInter) for different sub-blocks are shown in Table 1.

FIG. 21 illustrates the division method for angular modes.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.9. Combined Intra Block Copy and Intra Prediction

Combined intra block copy and intra prediction (IBC-CIIP) is a coding tool for a CU which uses IBC and intra prediction to obtain two prediction signals, and the two prediction signals are weighted summed to generate the final prediction as follows:

$$P = ( {w}_{ibc} * {P}_{ibc} + ( ( 1 << shift ) - {w}_{ibc} ) * {P}_{intra} + ( 1 << ( shift - 1 ) ) ) >> shift$$

wherein P_{ibc} and Pᵢₙₜᵣₐ denote the IBC prediction signal and intra prediction signal. (W_{ibc}, shift) are set equal to (13, 4) and (1, 1) for IBC merge mode and IBC AMVP mode.

An intra prediction mode (IPM) candidate list is used to generate the intra prediction signal, and the IPM candidate list size is pre-defined as 2. An IPM index is signalled to indicate which IPM is used.

FIG. 22 illustrates Subblock templates generation of SbTMVP.

### 2.10. Temporal Motion Derivation in ECM

In VVC, the Temporal Motion Vector Prediction (TMVP) for the AMVP and merge mode is derived by fetching the motion information from the center or the bottom-right of the collocated block in a signaled collocated picture. Similarly, for the Subblock-based Temporal Motion Vector Prediction (SbTMVP) mode, the motion information from the left neighboring position is used as a motion shift, which is then employed to obtain TMVPs at sub-CU level.

In ECM, to further improve the coding efficiency of TMVP, two aspects are modified. Firstly, two collocated pictures are utilized which are the two reference frames with the least POC distance relative to the to-be-coded frame. Secondly, the motion shift to locate TMVP is adaptively determined from multiple locations according to template costs. More specifically, two motion shift candidate lists are constructed respectively for the two collocated frames. The motion shifts with the minimum template matching cost are used to derive SbTMVP or TMVP candidates. At most 4 SbTMVP candidates are included in the sub-block-based merge list. The SbTMVP candidate with the least template matching cost derived from the first collocated frame is placed in the first entry without reordering, while other SbTMVP candidates are sorted together with affine candidates. In addition, the prediction direction of each subblock template is determined based on the center subblock. As illustrated in FIG. 22, if the center subblock is uni-predicted, then all the subblock templates are uni-predicted, and vice versa. If the motion vector of corresponding adjacent subblock at the determined reference list is not available for a subblock template, zero MV is used for that subblock template.

### 2.11. Multi-Pass Decoder-Side Motion Vector Refinement (DMVR)

A multi-pass decoder-side motion vector refinement is integrated in ECM. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.11.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and s Ver are determined by the block dimension, and the maximum value of sHor and sVer is 8.

The bilateral matching cost is calculated as: bilCost=mvDistanceCost+sadCost. When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV , MV1\_pass1 = MV 1 - deltaMV .$$

### 2.11.2 Second Pass—Subblock Based Bilateral Matching MV Refinement

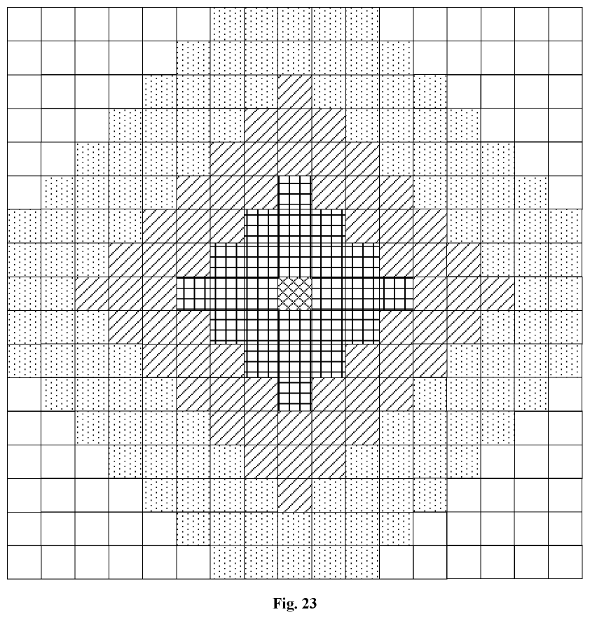

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1. For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8. The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 23. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

FIG. 23 illustrates diamond regions in the search area.

The existing VVC DMVR fractional sample refinement is further applied to derive the final deltaMV (sbIdx2). The refined MVs at second pass is then derived as:

$$MV0\_pass2 ( sbIdx 2 ) = MV0\_pass1 + deltaMV ( sbIdx 2 ) , MV1\_pass2 ( sbIdx 2 ) = MV1\_pass1 - deltaMV ( sbIdx 2 ) .$$

### 2.11.3 Third Pass-Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( sbIdx 3 ) = MV0\_pass2 ( sbIdx 2 ) + bioMv , MV1\_pass3 ( sbIdx 3 ) = MV0\_pass2 ( sbIdx 2 ) - bioMv .$$

In all aforementioned sub-clauses, when wrap around motion compensation is enabled, the motion vectors shall be clipped with wrap around offset taken into consideration.

### 3. Problems

Existing CIIP method has the following problems:
1) In VVC and ECM, CIIP allows only regular merge candidates as inter component, while subblock-based motion candidate, i.e., affine and SbTMVP, may bring additional benefits for blocks with complex motion.
2) How to blend subblock-based motion prediction with intra prediction and how the subblock-based CIIP interacts with other coding tools could be further specified.

### 4. Detailed Solutions

In this disclosure, it is proposed to further improve CIIP by allowing subblock-based prediction as inter component. In particular, intra prediction and subblock-based inter prediction can be blended to form the CIIP prediction.

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB. The term “subblock-based coding tools” may represent affine, SbTMVP, and the corresponding variants, and etc.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.). In the following discussion, The SE may be binarized as a fixed length code, an EG(x) code, a unary code, a truncated unary code, a truncated binary code, etc. It may be signed or unsigned.

It is noted that the terminologies mentioned below are not limited to the specific ones defined in existing standards. Any variance of the coding tool is also applicable.
1. The prediction that produced by a first coding tool may be blended with that of a second coding to form a third prediction.
   a) In one example, the first coding tool may be subblock-based method, e.g., affine, SbTMVP and so on.
   b) In one example, the second coding regular intra tool may be (Planar/DC/angular)/TIMD/DIMD/ISP/PDPC/MIP/IBC/regular inter, and so on.
2. It is proposed to use subblock-based coding tools to generate the inter component of CIIP, i.e., subblock-based CIIP.
   a) In one example, a first prediction may be generated with affine motion or SbTMVP, and a second prediction may be generated by intra mode, then the two predictions are blended with weighted-average to produce the final prediction of subblock-based CIIP.
   b) In one example, the intra mode may be Planar/DC/angular/MIP/ISP/IBC/Intra TMP, etc.
   c) In one example, the intra mode may be derived based on TIMD/DIMD/Intra TMP, etc.
   d) In one example, the intra component of subblock-based CIIP may be processed by PDPC.
3. A first subblock-based motion list may be constructed to provide motion information for subblock-based CIIP.
   a) In one example, the first subblock-based motion list may comprise at least one affine and/or at least one SbTMVP candidate(s).
      i. In one example, specifically, the first subblock-based motion list may include at least one adjacent/non-adjacent/history-based/regression-based/zero affine candidates.
      ii. In one example, specifically, the first subblock-based motion list may include at least one SbTMVP candidates.
         1) In one example, multiple SbTMVP candidates may appear in the list, which may be collected from at least one collocated frame.
   b) In one example, alternatively, the first subblock-based motion list may comprise only affine or SbTMVP candidates.
   c) In one example, the number of candidates in the list may not exceed a constant or an adaptively determined number.
   d) In one example, the first subblock-based motion list may be the same as a second subblock-based motion list that is used in subblock-based merge/AMVP mode.
      i. Alternatively, the first and second subblock-based motion lists may be different.
         1) In one example, the first and second subblock-based motion lists may be constructed with different maximum allowed candidate numbers.
         2) In one example, the first and second subblock-based motion lists may be constructed with different candidate types.
         3) In one example, the first subblock-based motion lists may be constructed by picking at least one candidate from the second subblock-based motion list.
4. The subblock-based motion list may be reordered based on certain metric after constructed.
   a) In one example, template matching or bilateral matching cost may be used to reorder the list.
      i. In one example, specifically, template matching cost may be used to reorder the list if reconstructed template region of the current block exists.
         1) In one example, alternatively, the list may not be reordered if reconstructed template region of the current block doesn't exist.
5. An index indicating specific candidate in the subblock-based motion list may be signalled in the bitstream.
   a) In one example, the candidate specified by an index may be used to provide subblock-based motion information and/or motion prediction.
      i. In one example, if the candidate specified by the index is an affine candidate, it may firstly be refined by TM or DMVR before used to generate inter prediction.
         1) In one example, if the specified candidate is a uni-predicted affine candidate, then TM may be used to refine the candidate, e.g., TM based CPMV refinement, and the refined candidate is used to provide prediction.
         2) In one example, alternatively, if the specified candidate is a bi-predicted affine candidate, then DMVR may be used to refine the candidate, and the refined candidate is used to provide prediction.
      ii. In one example, alternatively, no TM or DMVR processing is used to refine the specified affine candidate.
   b) In one example, no candidate index is signalled in the bitstream.
      i. In one example, encoder and decoder may generate a same subblock-based motion candidate based on a predefined rule, which is used to provide inter prediction.
         1) In one example, specifically, after subblock-based motion list is constructed, it may be reordered based on certain metrics, and the candidate that locates in a fixed position (e.g., the first/last/middle or any other position) may be used by default.
6. At least one syntax (or flag) indicating the usage of subblock-based CIIP may be signalled in the bitstream.
   a) In one example, at least one block level subblock-based CIIP flag may be signalled in the bitstream.
   b) In one example, at least one subblock-based CIIP flag in sequence level/group of pictures level/picture level/slice level/tile group level, such as in sequence header/picture header/SPS/VPS/DPS/DCI/PPS/APS/slice header/tile group header may be signalled in the bitstream.
   c) In one example, whether subblock-based CIIP flag is signalled or not, or whether subblock-based CIIP is applied or not may depend on the value of at least one another syntax.
      i. In one example, whether a subblock-based CIIP flag is signalled or not, or whether subblock-based CIIP is applied or not may depend on the value of at least one another sequence level/group of pictures level/picture level/slice level/tile group level syntax.
         1) In one example, whether a subblock-based CIIP flag is signalled or not may depend on the value of syntax that indicates whether CIIP and/or affine and/or SbTMVP is enabled or not.
      ii. In one example, whether a subblock-based CIIP flag is signalled or not, or whether subblock-based CIIP is applied or not may depend on the value of at least one another block level syntax.
         1) In one example, specifically, a subblock-based CIIP flag may be signalled only when CIIP/CIIP-PDPC/CIIP-TM/affine/SbTMVP flag is true or false.
         2) In one example, a first flag indicating the usage of CIIP (i.e., CIIP flag) may be signalled, if this flag is true, a second flag indicating the usage of subblock-based CIIP (i.e., subblock-based CIIP flag) may be signalled. If subblock-based CIIP flag is true, an index indicating subblock-based motion candidate may be signalled. Otherwise, if subblock-based CIIP flag is true, a third flag (i.e., CIIP-TM) may be signalled.
         a) In one example, alternatively, a first flag indicating the usage of CIIP (i.e., CIIP flag) may be signalled, if this flag is true, a second flag indicating the usage of CIIP-TM (i.e., CIIP-TM flag) may be signalled. If CIIP-TM flag is false, a third flag indicating the usage of subblock-based CIIP (i.e., subblock-based CIIP flag) may be signalled. If subblock-based CIIP flag is true, an index indicating subblock-based motion candidate may be signalled.
      iii. In one example, whether a subblock-based CIIP flag is signalled or not, or whether subblock-based CIIP is applied or not, may depend on the value of at least one syntax in sequence header/picture header/SPS/VPS/DPS/DCI/PPS/APS/slice header/tile group header is true or false.
   d) In one example, whether another flag is signalled or not may depend on the value of subblock-based CIIP flag.
      i. In one example, whether the flag indicating the usage of CIIP-TM/CIIP-PDPC and/or any other coding tool is signalled or not may depend on the value of subblock-based CIIP flag.
         1) In one example, when subblock-based CIIP flag is true, no CIIP-TM flag is signalled.
         a) In one example, alternatively, if subblock-based CIIP flag is false, a CIIP-TM flag is signalled.
         b) In one example, alternatively, a CIIP-TM flag is signalled no matter if subblock-based CIIP flag is true or false.
         2) In one example, when subblock-based CIIP flag is true, no CIIP-PDPC flag is signalled, and/or regular intra or PDPC intra is used by default.
         a) In one example, alternatively, if subblock-based CIIP flag is false, a CIIP-PDPC flag is signalled.
         b) In one example, alternatively, a CIIP-PDPC flag is signalled no matter if subblock-based CIIP flag is true or false.
   e) In one example, whether subblock-based CIIP flag is signalled may depend on the use condition of at least one another coding tool.
      i. In one example, a subblock-based CIIP flag may be signalled or subblock-based CIIP may be applied only when CIIP and/or affine, and/or SbTMVP is eligible to the current block.
      ii. In one example, a subblock-based CIIP flag is signalled or subblock-based CIIP is applied only when block dimension (e.g., width/height/ratio of width and height/block area) satisfies certain conditions.
7. On the blending of subblock-based CIIP mode.
   a) In one example, a same blending method that used by regular CIIP/CIIP-TM/CIIP-PDPC may be used by subblock-based CIIP.
      i. In one example, alternatively, a different blending method may be used by subblock-based CIIP.
   b) In one example, the blending weights may be position-dependent within a block.
      i. In one example, specifically, different locations may have different blending weights within the block.
      ii. In one example, a constant blending weight may be used for all the locations within the block.
   c) In one example, the blending weights matrix may be intra-mode-dependent.
      i. In one example, specifically, different blending weights matrix may be used depending on whether intra angular mode is near-vertical or near-horizontal.
8. For example, how to apply the sub-block-based prediction may be conditioned depending on whether it is used in subblock-based CIIP.
   a) For example, the sub-block size may be conditioned.
   b) For example, whether to and/or how to apply an operation may be conditioned.
      i. The operation may be PROF.
      ii. The operation may be interweaved affine.
      iii. The operation may be OBMC.
9. It is proposed that at least one affine information used in a first block, which is not an affine-merge coded or an affine-AMVP coded block, may be stored.
   a) In one example, the first block may be coded with GPM mode.
      i. In one example, affine motion compensation may be applied to generate the GPM prediction for the first block.
   b) In one example, the first block may be coded with CIIP or subblock-based CIIP mode.
      i. In one example, affine motion compensation may be applied to generate the CIIP prediction for the first block.
   c) In one example, the first block may be coded with MHP mode.
      i. In one example, affine motion compensation may be applied to generate the MHP prediction for the first block.
   d) In one example, the stored affine model may be utilized by at least one block coded/decoded after the first block.
   e) In one example, the affine information may comprise:
      i. Inter direction (uni from list 0, uni from list 1, or bi);
      ii. CPMVs (such as CPMVs at top-left, top-right and bottom-left corners);
      iii. Affine parameters (such as a, b, c, d, e, fin Eq. (1) and Eq. (2)).
      iv. Reference index to list 0;
      V. Reference index to list 1;
      vi. Local Illumination Compensation (LIC) flag;
      vii. Overlapped Block Motion Compensation (OBMC) flag;
      viii. bi-prediction with coding unit level weights (BCW) index;
      ix. Affine type (4-parameter or 6-parameter affine);
      X. Merge type (affine or sbTMVP);
      xi. Collocated picture index.
10. Affine information used in a first block coded with subblock-based CIIP may be used by blocks coded/decoded after the first block.
   a) In one example, the affine information of a subblock-based CIIP coded block may be put into the history-parameter table (HPT).
      i. In one example, HPT may be updated after encoding/decoder a subblock-based CIIP coded block.
   b) In one example, the affine information of a subblock-based CIIP coded block may be fetched and put into the affine merge/AMVP candidate list of a block coded/decoded after the first block.
   c) In one example, the affine information of a subblock-based CIIP coded block may be fetched and put into the affine candidate list of a second block coded with subblock-based CIIP mode or affine-GPM mode.
11. In one example, when trying to put one subblock-based CIIP inherited candidate into the new candidate list, it may be compared with at least one candidate already in the new candidate list.
   a) For example, the subblock-based CIIP inherited candidate may not be put into the new candidate list if it is the same to at least one candidate already in the new candidate list.
   b) For example, the subblock-based CIIP inherited candidate may not be put into the new candidate list if it is similar to at least one candidate already in the new candidate list.
12. When constructing an affine list including at least one affine candidate, such as a sub-block merge list or an affine merge list or an affine AMVP list or an affine list for GPM or an affine list for subblock-based CIIP, a specific sub-block or block covering a specific position adjacent or non-adjacent to the current block (such as A0, A1, B0, B1, and B2 in FIG. 8) may be checked with more than one mode, in a specific order.
   a) For example, whether the specific sub-block or block is affine coded (such as affine merge coded or affine AMVP coded), is checked firstly.
      i. For example, if the specific sub-block or block is affine coded, the affine information stored in or associated to the specific sub-block or block may be used to generate an affine candidate for the affine list.
   b) For example, whether the specific sub-block or block is GPM-affine or subblock-based CIIP coded, may be checked secondly.
      i. For example, if the specific sub-block or block is GPM-affine coded or subblock-based CIIP coded, the affine information stored in or associated to the specific sub-block or block may be used to generate an affine candidate for the affine list.
13. In one example, when constructing an affine list including at least one affine candidate, such as a sub-block merge list or an affine merge list or an affine AMVP list or an affine list for GPM or an affine list for subblock-based CIIP, a first sub-block or block covering a specific position adjacent or non-adjacent to the current block (such as A0, A1, B0, B1, and B2 in FIG. 8) may be checked to generate a candidate from a subblock-based CIIP coded block at a specific step in the list construction.
   a) E.g. the first sub-block or block may be checked to generate a candidate from a subblock-based CIIP coded block immediately after checking a specific inherited affine candidate from adjacent block.
   b) E.g. the first sub-block or block may be checked to generate a candidate from a subblock-based CIIP coded block immediately after checking a specific inherited affine candidate from non-adjacent block.
   c) E.g. the first sub-block or block may be checked to generate a candidate from a subblock-based CIIP coded block immediately after checking a specific RMVF affine candidate.
   d) E.g. the first sub-block or block may be checked to generate a candidate from a subblock-based CIIP coded block immediately after checking a specific constructed affine candidate.
   e) E.g. the first sub-block or block may be checked to generate a candidate from a subblock-based CIIP coded block immediately after checking temporal inherited affine candidate.
   f) E.g., the first sub-block or block may be checked to generate a candidate from a subblock-based CIIP coded block immediately after checking a history-based affine candidate.
14. It is proposed that a first SE related to CIIP may be coded with more than one context.
   a) In one example, the first SE may be the CIIP merge/MMVD index.
   b) In one example, the first SE may indicate the usage of CIIP-PDPC/CIIP-TM/subblock-based CIIP/CIIP-MMVD.
   c) In one example, the SE may be binarized into N bins denoted as B₀, B₁, . . . , B_{N-1}. In one example, Bn and Bₘ may be coded with different contexts if n!=m.
      i. In one example, B₀, B₁, . . . , B_{W} may be coded with different contexts denoted as C₀, ₁, . . . , C_{W}, respectively, while B_{W}, B_{W+1}, . . . , B_{N-1} may share the same context denoted as C_{W+1}. W is an integer such as 1, or 2, or 3, or 4, or 5, or 6, or 7.
      ii. In one example, B₀, B₁, . . . , B_{W} may be coded with different contexts denoted as C₀, C₁, . . . , C_{W}, respectively, while B_{W}, B_{W+1}, . . . , B_{N-1} may be bypass coded. W is an integer such as 1, or 2, or 3, or 4, or 5, or 6, or 7.
15. It is proposed that at least one context used to code a first SE related to CIIP may be selected based on coding information.
   a) In one example, the first SE may be the CIIP merge/MMVD index.
   b) In one example, the first SE may indicate the usage of CIIP-PDPC/CIIP-TM/subblock-based CIIP/CIIP-MMVD.
   c) In one example, the context selection may depend on whether subblock-based CIIP is used.
      i. For example, the context(s) used to code the CIIP merge/MMVD index of a CIIP block may be different when subblock-based CIIP is used.
      ii. For example, the context(s) used to indicate the usage of CIIP-PDPC/CIIP-TM/subblock-based CIIP/CIIP-MMVD of a CIIP block may be different when subblock-based CIIP is used.
   d) In one example, the context selection may depend on whether CIIP-PDPC/CIIP-TM/subblock-based CIIP/CIIP-MMVD is used or not.
   e) In one example, the context selection may depend on the QP.
   f) In one example, the context selection may depend on the slice type.
16. It is proposed that at least one context used to code a first SE related to CIIP may be selected based on coding information of at least one neighboring block.
   a) In one example, the first SE may be the CIIP merge index.
   b) In one example, the first SE may be the CIIP-MMVD index.
   c) In one example, the first SE may indicate the usage of CIIP-PDPC/CIIP-TM/subblock-based CIIP/CIIP-MMVD.
   d) In one example, the context to code an SE may be selected from a candidate set including more than one candidate contexts.
      i. In one example, the candidate set may include three members denoted as {C[0], C[1], C[2]}, and the selected context is C[S].
         1) S may depend on coding modes of at least one neighbouring block.
         2) For example, S is initialized to be 0. If the left neighbouring block is available and satisfies a specific condition, S is increased by 1; If the above neighbouring block is available and satisfies a specific condition, S is increased by 1.
         3) In one example, SE may be the subblock-based CIIP flag.
         4) In one example, the specific condition may be whether the neighbouring block is affine-coded.
         a) For example, a block may be considered as affine coded if it is coded with affine-AMVP mode.
         b) For example, a block may be considered as affine coded if it is coded with affine-merge mode.
         c) In one example, a block may be decoded as affine coded if its subblock-based CIIP is true.
17. In one example, the context used to code affine flag of a block may depend on whether a neighbouring block is coded with subblock-based CIIP mode.
   a) In one example, the context to code the affine flag may be selected from a candidate set including more than one candidate context.
   b) In one example, the candidate set may include three members denoted as {C[0], C[1], C[2]}, and the selected context is C[S].
      i. For example, S is initialized to be 0. If the left neighbouring block is available and satisfies a specific condition, S is increased by 1; If the above neighbouring block is available and satisfies a specific condition, S is increased by 1.
      ii. In one example, the specific condition may be whether the neighbouring block is affine-coded.
         1) For example, a block may be considered as affine coded if it is coded with affine-AMVP mode.
         2) For example, a block may be considered as affine coded if it is coded with affine-merge mode.
         3) In one example, a block may be decoded as affine coded if its subblock-based CIIP flag is true.
   c) For example, the context may be selected based on the number (denoted as N) of available affine-coded neighbouring blocks.
      i. For example, a first context may be used if N<=T and a second context may be used if N>T. T is an integer such as 0, or 1, or 2, or 3, or 4, or 5, or 6.
      ii. Five neighbouring blocks as in FIG. 4 or seven neighbouring samples as in FIG. 10 may be included. For example, a block may be considered as affine coded if it is coded with affine-AMVP mode. iii.
      iv. For example, a block may be considered as affine coded if it is coded with affine-merge mode.
      v. In one example, a block may be decoded as affine coded if its subblock-based CIIP flag is true.
18. The maximum allowed value of a first SE may depend on whether subblock-based CIIP is used.
   a) In one example, the first SE may be the CIIP merge index.
   b) In one example, the first SE may be the CIIP-MMVD index.
   c) In one example, the first SE may indicate the usage of CIIP-PDPC/CIIP-TM/subblock-based CIIP/CIIP-MMVD.
   d) The maximum allowed value may determine the last valid codeword of the SE if it is coded with a truncated unary code such as a truncated unary code or a truncated binary code.
   e) For example, the allowed value of the first SE may be signalled such as in VPS/SPS/PPS/picture header/slice header for the affine-coded case and the non-affine-coded case individually.
19. In one example, the maximum allowed value of a first SE may be determined based on the number (denoted as N) of available affine-coded neighbouring blocks.
   a) In one example, the first SE may be the CIIP merge index.
   b) In one example, the first SE may be the CIIP-MMVD index.
   c) In one example, the first SE may indicate the usage of CIIP-PDPC/CIIP-TM/subblock-based CIIP/CIIP-MMVD.
   d) For example, the first maximum allowed value may be used if N<=T and a second maximum allowed value may be used if N>T. T is an integer such as 0, or 1, or 2, or 3, or 4, or 5, or 6.
   e) Five neighbouring blocks as in FIG. 4 or seven neighbouring samples as in FIG. 10 may be included.
   f) For example, a block may be considered as affine coded if it is coded with affine-AMVP mode.
   g) For example, a block may be considered as affine coded if it is coded with affine-merge mode.
   h) In one example, a block may be decoded as affine coded if its subblock-based CIIP flag is true.

### General Information

20. In above examples, the video unit may refer to the video unit may refer to color component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
21. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
22. Whether and/or how to apply the above methods may depend on the following information:
   a) A message signalled in the DPS/SPS/VPS/PPS/APS/picture header/slice header/tile group header/Largest coding unit (LCU)/Coding unit (CU)/LCU row/group of LCUs/TU/PU block/Video coding unit.
   b) Position of CU/PU/TU/block/Video coding unit.
   c) Block dimension of current block and/or its neighbouring blocks.
   d) Block shape of current block and/or its neighbouring blocks.
   e) coded mode of a block, e.g., IBC or non-IBC inter mode or non-IBC subblock mode.
   f) Indication of the color format (such as 4:2:0, 4:4:4).
   g) Coding tree structure.
   h) Slice/tile group type and/or picture type.
   i) Color component (e.g., may be only applied on chroma components or luma component).
   j) Temporal layer ID.
   k) Profiles/Levels/Tiers of a standard.

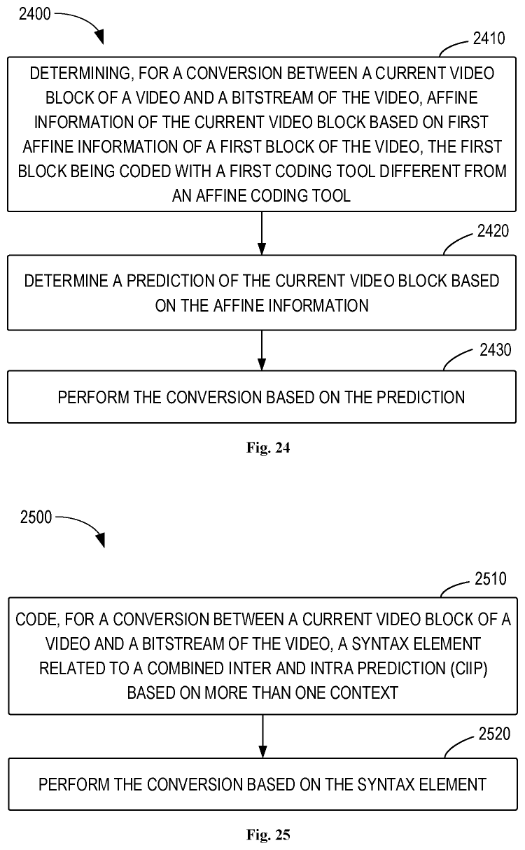

FIG. 24 illustrates a flowchart of a method 2400 for video processing in accordance with embodiments of the present disclosure. The method 2400 is implemented during a conversion between a video unit of a video and a bitstream of the video.

At block 2410, for a conversion between a current video block of a video and a bitstream of the video, affine information of the current video block is determined based on first affine information of a first block of the video. The first block is coded with a first coding tool different from an affine coding tool.

At block 2420, a prediction of the current video block is determined based on the affine information.

At block 2430, the conversion is performed based on the prediction. In some embodiments, the conversion includes encoding the current video block into the bitstream. Alternatively, or in addition, in some embodiments, the conversion includes decoding the current video block from the bitstream.

The method 2400 enables generating a prediction with affine information of a block being coded with a coding tool different from an affine coding tool. In this way, the coding effectiveness and coding efficiency can be improved.

In some embodiments, the first block is coded with at least one of a combined inter and intra prediction (CIIP) mode or a subblock-based CIIP mode.

In some embodiments, an affine motion compensation is applied to generate a CIIP prediction of the first block.

In some embodiments, the affine information comprises at least one of: an inter direction, a control point motion vector (CPMV), an affine parameter, at least one reference index of at least one reference picture list, a local illumination compensation (LIC) flag, an overlapped block motion compensation (OBMC) flag, a bi-prediction with coding unit level weights (BCW) index, an affine type (e.g., 4-parameter or 6-parameter affine), a merge type (e.g., affine or sbTMVP), or a collocated picture index. For example, the inter direction may include a uni-directional prediction from list 0 or list 1 or a bi-directional prediction. In an example, the CPMV may include CPMVs at top-left, top-right and bottom-left corners. By way of example, the affine parameters may be a, b, c, d, e, fin Eq. (1) and Eq. (2).

In some embodiments, the first block is coded with a geometric partitioning mode (GPM).

In some embodiments, an affine motion compensation is applied to generate a GPM prediction of the first block.

In some embodiments, the first block is coded with a multi-hypothesis prediction (MHP) mode.

In some embodiments, an affine motion compensation is applied to generate a MHP prediction of the first block.

In some embodiments, an affine model comprised in the affine information is utilized by at least one block coded after the first block.

In some embodiments, the affine information is used by at least one block coded after the first block, the first block being coded with the subblock-based CIIP.

In some embodiments, the affine information of the first block is comprised in a history-parameter table (HPT).

In some embodiments, the HPT is updated after at least one of encoding or decoding a subblock-based CIIP coded block.

In some embodiments, the affine information of the first block is included in at least one of an affine merge list or an advanced motion vector prediction (AMVP) candidate list of a block coded after the first block.

In some embodiments, the affine information of the first block is included in an affine candidate list of a second block coded with at least one of the subblock-based CIIP mode or an affine-GPM mode.

In some embodiments, the method 2400 further comprising: determining to include the affine information in the affine candidate list based on a comparison between the affine information and at least one affine candidate in the affine candidate list.

In some embodiments, in response to that the affine information is the same to the at least one affine candidate in the affine candidate list, the affine information is excluded from the affine candidate list.

In some embodiments, in response to that a difference between the affine information and the at least one affine candidate in the affine candidate list is less than or equal to a threshold, the affine information is excluded from the affine candidate list.

In some embodiments, the method 2400 further comprises: constructing an affine list based on checking at least one of a sub-block or a block covering a position related to the current video block. For example, the position related to the current video block may be implemented as A0, A1, B0, B1, and B2 in FIG. 5.

In some embodiments, the affine candidate list comprises at least one of: a sub-block merge list, an affine merge list, an affine AMVP list, an affine list for GPM, or an affine list for subblock-based CIIP.

In some embodiments, the method 2400 further comprises: determining whether the coding tool for the at least one of a sub-block or a block is an affine-based coding tool. By way of example, the coding tool may include an affine merge or an affine AMVP.

In some embodiments, the method 2400 further comprises: in accordance with a determination that the coding tool is an affine-based coding tool, using affine information related to the at least one of a sub-block or a block to generate an affine candidate for the affine candidate list.

In some embodiments, the method 2400 further comprises: determining whether the coding tool for the at least one of a sub-block or a block is at least one of an GPM-affine-based coding tool or a subblock-based CIIP coding tool.

In some embodiments, the method 2400 further comprises: in accordance with a determination that the coding tool is at least one of an GPM-affine-based coding tool or a subblock-based CIIP coding tool, using affine information related to the at least one of a sub-block or a block to generate an affine candidate for the affine candidate list.

In some embodiments, the at least one of a sub-block or a block is checked to generate the affine candidate from a subblock-based CIIP coded block.

In some embodiments, after checking an inherited affine candidate from a block which is adjacent to the current block, the at least one of a sub-block or a block is checked to generate the affine candidate from the subblock-based CIIP coded block immediately.

In some embodiments, after checking an inherited affine candidate from a block which is non-adjacent to the current block, the at least one of a sub-block or a block is checked to generate the affine candidate from the subblock-based CIIP coded block immediately.

In some embodiments, after checking a regression-based motion vector field (RMVF) affine candidate, the at least one of a sub-block or a block is checked to generate the affine candidate from the subblock-based CIIP coded block immediately.

In some embodiments, after checking a constructed affine candidate, the at least one of a sub-block or a block is checked to generate the affine candidate from the subblock-based CIIP coded block immediately.

In some embodiments, after checking a temporal inherited affine candidate, the at least one of a sub-block or a block is checked to generate the affine candidate from the subblock-based CIIP coded block immediately.

In some embodiments, after checking a history-based affine candidate, the at least one of a sub-block or a block is checked to generate the affine candidate from the subblock-based CIIP coded block immediately.

According to further embodiments of the present disclosure, a non-transitory computer-readable recording medium is provided. The non-transitory computer-readable recording medium stores a bitstream of a video which is generated by a method performed by an apparatus for video processing. The method comprises: determining affine information of the current video block based on first affine information of a first block of the video, the first block being coded with a first coding tool different from an affine coding tool; determining a prediction of the current video block based on the affine information; and generating the bitstream based on the prediction.

According to still further embodiments of the present disclosure, a method for storing bitstream of a video is provided. The method comprises: determining affine information of the current video block based on first affine information of a first block of the video, the first block being coded with a first coding tool different from an affine coding tool; determining a prediction of the current video block based on the affine information; generating the bitstream based on the prediction; and storing the bitstream in a non-transitory computer-readable recording medium.

FIG. 25 illustrates a flowchart of a method 2500 for video processing in accordance with embodiments of the present disclosure. The method 2500 is implemented during a conversion between a video unit of a video and a bitstream of the video.

At block 2510, for a conversion between a current video block of a video and a bitstream of the video, a syntax element related to a combined inter and intra prediction (CIIP) is coded based on more than one context.

At block 2520, the conversion is performed based on the syntax element. Alternatively, or in addition, in some embodiments, the conversion includes decoding the current video block from the bitstream.

The method 2500 enables coding a syntax element related to a CIIP with at least one context. In this way, the coding effectiveness and coding efficiency can be improved.

In some embodiments, the syntax element is an index of at least one of a CIIP merge or a merge mode with motion vector difference (MMVD).

In some embodiments, the syntax element indicates a usage of at least one of: a CIIP-Position dependent intra prediction combination (PDPC), a CIIP-template matching (TM), a subblock based CIIP, or a CIIP-MMVD.

In some embodiments, the syntax element is binarized into N bins, N being an integer. For example, the syntax element may be binarized into N bins denoted as B₀, B₁, . . . , B_{N-1}. In one example, Bn and Bm may be coded with different contexts if n!=m.

In some embodiments, a first number of bins of the N bins are coded with different contexts, and remaining bins of the N bins are coded with a same context, wherein the first number is one of: 1, 2, 3, 4, 5, 6 or 7. By way of example, B₀, B₁, . . . , B_{W} may be coded with different contexts denoted as C₀, C₁, . . . , C_{W}, respectively. Furthermore, B_{W}, B_{W+1}, . . . , B_{N-1} may share the same context denoted as C_{W+1}. Specifically, W is an integer such as 1, 2, 3, 4, 5, 6 or 7.

In some embodiments, a first number of bins of the N bins are coded with different contexts, and remaining bins of the N bins are bypass coded, wherein the first number is one of: 1, 2, 3, 4, 5, 6 or 7. For example, B₀, B₁, . . . , B_{W} may be coded with different contexts denoted as C₀, C₁, . . . , C_{W}, respectively. Furthermore, B_{W}, B_{W+1}, . . . , B_{N-1} may be bypass coded. Specifically, W is an integer such as 1, 2, 3, 4, 5, 6 or 7.

In some embodiments, at least one context used to code the syntax element is determined based on coding information.

In some embodiments, the at least one context is determined based on whether a subblock-based CIIP is used.

In some embodiments, the at least one context used to code an index of at least one of a CIIP merge or a MMVD of a CIIP block is determined based on whether a subblock-based CIIP is used.

In some embodiments, the at least one context used to indicate a usage of at least one of: a CIIP-PDPC, a CIIP-TM, a subblock based CIIP, or a CIIP-MMVD is determined based on whether a subblock-based CIIP is used.

In some embodiments, the at least one context is determined based on whether at least one of: a CIIP-PDPC, a CIIP-TM, a subblock based CIIP, or a CIIP-MMVD is used.

In some embodiments, the at least one context is determined based on quantization parameter (QP).

In some embodiments, the at least one context is determined based on a slice type.

In some embodiments, the coding information is associated with at least one neighboring block.

In some embodiments, the at least one context is selected from a candidate set including at least one candidate context. For example, the candidate set may include three members denoted as {C[0], C[1], C[2]}, and the selected context is C[S].

In some embodiments, an index of a selected candidate context is determined based on at least one neighbouring block.

In some embodiments, the index is determined by: initializing the index to be 0; and in response to the at least one neighbouring block is available and satisfies a condition, increasing the index by 1, wherein the at least one neighbouring block comprises at least one of a left neighbouring block or a above neighbouring block. By way of example, S is initialized to be 0. In an example, if the left neighbouring block is available and satisfies a specific condition, S is increased by 1. Alternatively or in addition, if the above neighbouring block is available and satisfies a specific condition, S is increased by 1.

In some embodiments, the condition comprises that the at least one neighbouring block is affine-coded.

In some embodiments, the at least one neighbouring block coded with an affine-advanced motion vector prediction (AMVP) mode is considered as affine-coded.

In some embodiments, the at least one neighbouring block coded with an affine-merge mode is considered as affine-coded.

In some embodiments, the at least one neighbouring block with a subblock-based CIIP being true is considered as affine-coded.

In some embodiments, the syntax element is a subblock-based CIIP flag.

In some embodiments, at least one context for an affine flag of a block is determined based on whether at least one neighbouring block of the block is coded with a subblock-based CIIP mode.

In some embodiments, the at least one context is selected from a candidate set including at least one candidate context. For example, the candidate set may include three members denoted as {C[0], C[1], C[2]}, and the selected context is C[S].

In some embodiments, the at least one context is selected by: in response to the at least one neighbouring block is available and satisfies a condition, increasing an index of a selected candidate context by 1; and selecting the at least one context based on the index, wherein the index is initialized to be 0, and the at least one neighbouring block comprises at least one of a left neighbouring block or a above neighbouring block. By way of example, S is initialized to be 0. In one example, if the left neighbouring block is available and satisfies a specific condition, S is increased by 1. Alternatively, or in addition, if the above neighbouring block is available and satisfies a specific condition, S is increased by 1.

In some embodiments, the condition comprises that the at least one neighbouring block is affine-coded.

In some embodiments, the at least one neighbouring block coded with an affine-advanced motion vector prediction (AMVP) mode is considered as affine-coded.

In some embodiments, the at least one neighbouring block coded with an affine-merge mode is considered as affine-coded.

In some embodiments, the at least one neighbouring block with a subblock-based CIIP being true is considered as affine-coded.

In some embodiments, the at least one context is selected based on a number of available affine-coded neighbouring blocks.

In some embodiments, if the number of available affine-coded neighbouring blocks is smaller than or equal to a threshold, a first context is used, and if the number is larger than the threshold, a second context is used, wherein the threshold is an integer.

In some embodiments, the threshold is 0, 1, 2, 3, 4, 5, or 6.

In some embodiments, the available affine-coded neighbouring blocks comprise five neighbouring blocks or seven neighbouring samples. For example, examples of the five neighboring blocks are illustrated in FIG. 4. Moreover, examples of the seven neighboring samples are illustrated in FIG. 10.

In some embodiments, the at least one neighbouring block coded with an affine-advanced motion vector prediction (AMVP) mode is considered as affine-coded.

In some embodiments, the at least one neighbouring block coded with an affine-merge mode is considered as affine-coded.

In some embodiments, the at least one neighbouring block with a subblock-based CIIP being true is considered as affine-coded.

In some embodiments, a maximum value of the syntax element is determined based on whether a subblock-based CIIP is used.

In some embodiments, if the syntax element is coded with at least one of a truncated unary code or a truncated binary code, a last valid codeword of the syntax element is determined based on the maximum value.

In some embodiments, the maximum value of the syntax element is indicated in at least one of the following for an affine-coded block and a non-affine-coded block individually: a video parameter set (VPS), a sequence parameter set (SPS), a picture parameter set (PPS), a picture header, or a slice header.

In some embodiments, the maximum value is determined based on the number of available affine-coded neighboring blocks.

In some embodiments, if the number of available affine-coded neighbouring blocks is smaller than or equal to a threshold, a first context is used, and if the number is larger than the threshold, a second context is used, wherein the threshold is an integer.

In some embodiments, the threshold is 0, 1, 2, 3, 4, 5, or 6.

In some embodiments, the available affine-coded neighbouring blocks comprise five neighbouring blocks or seven neighbouring samples. For example, examples of the five neighboring blocks are illustrated in FIG. 4. Moreover, examples of the seven neighboring samples are illustrated in FIG. 10.

In some embodiments, the at least one neighbouring block coded with an affine-advanced motion vector prediction (AMVP) mode is considered as affine-coded.

In some embodiments, the at least one neighbouring block coded with an affine-merge mode is considered as affine-coded.

In some embodiments, the at least one neighbouring block with a subblock-based CIIP being true is considered as affine-coded.

In some embodiments, the current video block or a video unit comprises at least one of: a colour component, a sub-picture, a slice, a tile, a coding tree unit (CTU), a CTU row, a groups of CTU, a coding unit (CU), a prediction unit (PU), a transform unit (TU), a coding tree block (CTB), a coding block (CB), a prediction block (PB), a transform block (TB), a block, sub-block of a block, sub-region within a block, or a region that contains more than one sample or pixel.

In some embodiments, an indication of whether to and/or how to apply the method 2400 and/or the method 2500 is indicated at one of: a sequence level, a group of pictures level, a picture level, a slice level, or a tile group level.

In some embodiments, an indication of whether to and/or how to apply the method 2400 and/or the method 2500 is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method 2400 and/or the method 2500 is based on at least one of: a message included in one of: a dependency parameter set (DPS), a sequence parameter set (SPS), a video parameter set (VPS), a picture parameter set (PPS), an adaptation parameter sets (APS), a picture header, a slice header, a tile group header, a largest coding unit (LCU), a coding unit (CU), a LCU row, a group of LCUs, a transform unit (TU), a prediction unit (PU) block, or a video coding unit, a position of CU, PU, TU, block, or the video coding unit, a block dimension of the current video block and/or neighboring blocks of the current video block, a block shape of the current video block and/or neighboring blocks of the current video block, a coded mode of a block, an indication of a color format, a coding tree structure, a slice, tile group type and/or picture type, a colour component, a temporal layer identifier (ID), or profiles, levels, or tiers of a standard.

In some embodiments, the coded mode comprises one of: an intra block copy (IBC), a non-IBC inter mode, or a non-IBC subblock mode, or wherein the color format comprises one of: 4:2:0, or 4:4:4.

In some embodiments, the conversion comprises encoding the current video block into the bitstream.

In some embodiments, the conversion comprises decoding the current video block from the bitstream.

According to further embodiments of the present disclosure, a non-transitory computer-readable recording medium is provided. The non-transitory computer-readable recording medium stores a bitstream of a video which is generated by a method performed by an apparatus for video processing. The method comprises: coding a syntax element related to a combined inter and intra prediction (CIIP) based on more than one context; and generating the bitstream based on the syntax element.

According to still further embodiments of the present disclosure, a method for storing bitstream of a video is provided. The method comprises: coding a syntax element related to a combined inter and intra prediction (CIIP) based on more than one context; generating the bitstream based on the syntax element; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, affine information of the current video block based on first affine information of a first block of the video, the first block being coded with a first coding tool different from an affine coding tool; determining a prediction of the current video block based on the affine information; and perform the conversion based on the prediction.

Clause 2. The method of clause 1, wherein the first block is coded with at least one of a combined inter and intra prediction (CIIP) mode or a subblock-based CIIP mode.

Clause 3. The method of clause 2, wherein an affine motion compensation is applied to generate a CIIP prediction of the first block.

Clause 4. The method of clause 1, wherein the affine information comprises at least one of: an inter direction, a control point motion vector (CPMV), an affine parameter, at least one reference index of at least one reference picture list, a local illumination compensation (LIC) flag, an overlapped block motion compensation (OBMC) flag, a bi-prediction with coding unit level weights (BCW) index, an affine type, a merge type, or a collocated picture index.

Clause 5. The method of clause 1, wherein the first block is coded with a geometric partitioning mode (GPM).

Clause 6. The method of clause 5, wherein an affine motion compensation is applied to generate a GPM prediction of the first block.

Clause 7. The method of clause 1, wherein the first block is coded with a multi-hypothesis prediction (MHP) mode.

Clause 8. The method of clause 7, wherein an affine motion compensation is applied to generate a MHP prediction of the first block.

Clause 9. The method of any of clauses 1 to 8, wherein an affine model comprised in the affine information is utilized by at least one block coded after the first block.

Clause 10. The method of clause 2, wherein the affine information is used by at least one block coded after the first block, the first block being coded with the subblock-based CIIP.

Clause 11. The method of clause 10, wherein the affine information of the first block is comprised in a history-parameter table (HPT).

Clause 12. The method of clause 11, wherein the HPT is updated after at least one of encoding or decoding a subblock-based CIIP coded block.

Clause 13. The method of clause 10, wherein the affine information of the first block is included in at least one of an affine merge list or an advanced motion vector prediction (AMVP) candidate list of a block coded after the first block.

Clause 14. The method of clause 10, wherein the affine information of the first block is included in an affine candidate list of a second block coded with at least one of the subblock-based CIIP mode or an affine-GPM mode.

Clause 15. The method of clause 13 or claim 14, further comprising: determining to include the affine information in the affine candidate list based on a comparison between the affine information and at least one affine candidate in the affine candidate list.

Clause 16. The method of clause 15, wherein in response to that the affine information is the same to the at least one affine candidate in the affine candidate list, the affine information is excluded from the affine candidate list.

Clause 17. The method of clause 15, wherein in response to that a difference between the affine information and the at least one affine candidate in the affine candidate list is less than or equal to a threshold, the affine information is excluded from the affine candidate list.

Clause 18. The method of clause 1, further comprising: constructing an affine list based on checking at least one of a sub-block or a block covering a position related to the current video block.

Clause 19. The method of clause 18, wherein the affine candidate list comprises at least one of: a sub-block merge list, an affine merge list, an affine AMVP list, an affine list for GPM, or an affine list for subblock-based CIIP.

Clause 20. The method of clause 18 or claim 19, further comprising: determining whether the coding tool for the at least one of a sub-block or a block is an affine-based coding tool.

Clause 21. The method of clause 20, further comprising: in accordance with a determination that the coding tool is an affine-based coding tool, using affine information related to the at least one of a sub-block or a block to generate an affine candidate for the affine candidate list.

Clause 22. The method of clause 18 or claim 19, further comprising: determining whether the coding tool for the at least one of a sub-block or a block is at least one of an GPM-affine-based coding tool or a subblock-based CIIP coding tool.

Clause 23. The method of clause 22, further comprising: in accordance with a determination that the coding tool is at least one of an GPM-affine-based coding tool or a subblock-based CIIP coding tool, using affine information related to the at least one of a sub-block or a block to generate an affine candidate for the affine candidate list.

Clause 24. The method of clause 18-23, wherein the at least one of a sub-block or a block is checked to generate the affine candidate from a subblock-based CIIP coded block.

Clause 25. The method of clause 24, wherein after checking an inherited affine candidate from a block which is adjacent to the current block, the at least one of a sub-block or a block is checked to generate the affine candidate from the subblock-based CIIP coded block immediately.

Clause 26. The method of clause 24, wherein after checking an inherited affine candidate from a block which is non-adjacent to the current block, the at least one of a sub-block or a block is checked to generate the affine candidate from the subblock-based CIIP coded block immediately.

Clause 27. The method of clause 24, wherein after checking a regression-based motion vector field (RMVF) affine candidate, the at least one of a sub-block or a block is checked to generate the affine candidate from the subblock-based CIIP coded block immediately.

Clause 28. The method of clause 24, wherein after checking a constructed affine candidate, the at least one of a sub-block or a block is checked to generate the affine candidate from the subblock-based CIIP coded block immediately.

Clause 29. The method of clause 24, wherein after checking a temporal inherited affine candidate, the at least one of a sub-block or a block is checked to generate the affine candidate from the subblock-based CIIP coded block immediately.

Clause 30. The method of clause 24, wherein after checking a history-based affine candidate, the at least one of a sub-block or a block is checked to generate the affine candidate from the subblock-based CIIP coded block immediately.

Clause 31. A method for video processing, comprising: coding, for a conversion between a current video block of a video and a bitstream of the video, a syntax element related to a combined inter and intra prediction (CIIP) based on more than one context; and performing the conversion based on the syntax element.

Clause 32. The method of clause 31, wherein the syntax element is an index of at least one of a CIIP merge or a merge mode with motion vector difference (MMVD).

Clause 33. The method of clause 31, wherein the syntax element indicates a usage of at least one of: a CIIP-Position dependent intra prediction combination (PDPC), a CIIP-template matching (TM), a subblock based CIIP, or a CIIP-MMVD.

Clause 34. The method of clause 31, wherein the syntax element is binarized into N bins, N being an integer.

Clause 35. The method of clause 34, wherein a first number of bins of the N bins are coded with different contexts, and remaining bins of the N bins are coded with a same context, wherein the first number is one of: 1, 2, 3, 4, 5, 6 or 7.

Clause 36. The method of clause 34, wherein a first number of bins of the N bins are coded with different contexts, and remaining bins of the N bins are bypass coded, wherein the first number is one of: 1, 2, 3, 4, 5, 6 or 7.

Clause 37. The method of any of clauses 31 to 33, wherein at least one context used to code the syntax element is determined based on coding information.

Clause 38. The method of clause 37, wherein the at least one context is determined based on whether a subblock-based CIIP is used.

Clause 39. The method of clause 38, wherein the at least one context used to code an index of at least one of a CIIP merge or a MMVD of a CIIP block is determined based on whether a subblock-based CIIP is used.

Clause 40. The method of clause 38, wherein the at least one context used to indicate a usage of at least one of: a CIIP-PDPC, a CIIP-TM, a subblock based CIIP, or a CIIP-MMVD is determined based on whether a subblock-based CIIP is used.

Clause 41. The method of clause 38, wherein the at least one context is determined based on whether at least one of: a CIIP-PDPC, a CIIP-TM, a subblock based CIIP, or a CIIP-MMVD is used.

Clause 42. The method of clause 38, wherein the at least one context is determined based on quantization parameter (QP).

Clause 43. The method of clause 38, wherein the at least one context is determined based on a slice type.

Clause 44. The method of clause 37, wherein the coding information is associated with at least one neighboring block.

Clause 45. The method of clause 44, wherein the at least one context is selected from a candidate set including at least one candidate context.

Clause 46. The method of clause 45, wherein an index of a selected candidate context is determined based on at least one neighbouring block.

Clause 47. The method of clause 46, wherein the index is determined by: initializing the index to be 0; and in response to the at least one neighbouring block is available and satisfies a condition, increasing the index by 1, wherein the at least one neighbouring block comprises at least one of a left neighbouring block or a above neighbouring block.

Clause 48. The method of clause 47, wherein the condition comprises that the at least one neighbouring block is affine-coded.

Clause 49. The method of clause 48, wherein the at least one neighbouring block coded with an affine-advanced motion vector prediction (AMVP) mode is considered as affine-coded.

Clause 50. The method of clause 48, wherein the at least one neighbouring block coded with an affine-merge mode is considered as affine-coded.

Clause 51. The method of clause 48, wherein the at least one neighbouring block with a subblock-based CIIP being true is considered as affine-coded.

Clause 52. The method of clause 46, wherein the syntax element is a subblock-based CIIP flag.

Clause 53. The method of clause 31, wherein at least one context for an affine flag of a block is determined based on whether at least one neighbouring block of the block is coded with a subblock-based CIIP mode.

Clause 54. The method of clause 53, wherein the at least one context is selected from a candidate set including at least one candidate context.

Clause 55. The method of clause 54, wherein the at least one context is selected by: in response to the at least one neighbouring block is available and satisfies a condition, increasing an index of a selected candidate context by 1; and selecting the at least one context based on the index, wherein the index is initialized to be 0, and the at least one neighbouring block comprises at least one of a left neighbouring block or a above neighbouring block.

Clause 56. The method of clause 55, wherein the condition comprises that the at least one neighbouring block is affine-coded.

Clause 57. The method of clause 56, wherein the at least one neighbouring block coded with an affine-advanced motion vector prediction (AMVP) mode is considered as affine-coded.

Clause 58. The method of clause 56, wherein the at least one neighbouring block coded with an affine-merge mode is considered as affine-coded.

Clause 59. The method of clause 56, wherein the at least one neighbouring block with a subblock-based CIIP being true is considered as affine-coded.

Clause 60. The method of clause 54, wherein the at least one context is selected based on a number of available affine-coded neighbouring blocks.

Clause 61. The method of clause 60, wherein if the number of available affine-coded neighbouring blocks is smaller than or equal to a threshold, a first context is used, and if the number is larger than the threshold, a second context is used, wherein the threshold is an integer.

Clause 62. The method of clause 61, wherein the threshold is 0, 1, 2, 3, 4, 5, or 6.

Clause 63. The method of clause 60, wherein the available affine-coded neighbouring blocks comprise five neighbouring blocks or seven neighbouring samples.

Clause 64. The method of clause 60, wherein the at least one neighbouring block coded with an affine-advanced motion vector prediction (AMVP) mode is considered as affine-coded.

Clause 65. The method of clause 60, wherein the at least one neighbouring block coded with an affine-merge mode is considered as affine-coded.

Clause 66. The method of clause 60, wherein the at least one neighbouring block with a subblock-based CIIP being true is considered as affine-coded.

Clause 67. The method of any of clauses 31 to 33, wherein a maximum value of the syntax element is determined based on whether a subblock-based CIIP is used.

Clause 68. The method of clause 67, wherein if the syntax element is coded with at least one of a truncated unary code or a truncated binary code, a last valid codeword of the syntax element is determined based on the maximum value.

Clause 69. The method of clause 68, wherein the maximum value of the syntax element is indicated in at least one of the following for an affine-coded block and a non-affine-coded block individually: a video parameter set (VPS), a sequence parameter set (SPS), a picture parameter set (PPS), a picture header, or a slice header.

Clause 70. The method of clause 67, wherein the maximum value is determined based on the number of available affine-coded neighboring blocks.

Clause 71. The method of clause 70, wherein if the number of available affine-coded neighbouring blocks is smaller than or equal to a threshold, a first context is used, and if the number is larger than the threshold, a second context is used, wherein the threshold is an integer.

Clause 72. The method of clause 71, wherein the threshold is 0, 1, 2, 3, 4, 5, or 6.

Clause 73. The method of clause 70, wherein the available affine-coded neighbouring blocks comprise five neighbouring blocks or seven neighbouring samples.

Clause 74. The method of clause 70, wherein the at least one neighbouring block coded with an affine-advanced motion vector prediction (AMVP) mode is considered as affine-coded.

Clause 75. The method of clause 70, wherein the at least one neighbouring block coded with an affine-merge mode is considered as affine-coded.

Clause 76. The method of clause 70, wherein the at least one neighbouring block with a subblock-based CIIP being true is considered as affine-coded.

Clause 77. The method of any of clauses 1-76, wherein the current video block or a video unit comprises at least one of: a colour component, a sub-picture, a slice, a tile, a coding tree unit (CTU), a CTU row, a groups of CTU, a coding unit (CU), a prediction unit (PU), a transform unit (TU), a coding tree block (CTB), a coding block (CB), a prediction block (PB), a transform block (TB), a block, sub-block of a block, sub-region within a block, or a region that contains more than one sample or pixel.

Clause 78. The method of any of clauses 1-77, wherein an indication of whether to and/or how to apply the method is indicated at one of: a sequence level, a group of pictures level, a picture level, a slice level, or a tile group level.

Clause 79. The method of any of clauses 1-77, wherein an indication of whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 80. The method of any of clauses 1-77, wherein whether to and/or how to apply the method is based on at least one of: a message included in one of: a dependency parameter set (DPS), a sequence parameter set (SPS), a video parameter set (VPS), a picture parameter set (PPS), an adaptation parameter sets (APS), a picture header, a slice header, a tile group header, a largest coding unit (LCU), a coding unit (CU), a LCU row, a group of LCUs, a transform unit (TU), a prediction unit (PU) block, or a video coding unit, a position of CU, PU, TU, block, or the video coding unit, a block dimension of the current video block and/or neighboring blocks of the current video block, a block shape of the current video block and/or neighboring blocks of the current video block, a coded mode of a block, an indication of a color format, a coding tree structure, a slice, tile group type and/or picture type, a colour component, a temporal layer identifier (ID), or profiles, levels, or tiers of a standard.

Clause 81. The method of clause 80, wherein the coded mode comprises one of: an intra block copy (IBC), a non-IBC inter mode, or a non-IBC subblock mode, or wherein the color format comprises one of: 4:2:0, or 4:4:4.

Clause 82. The method of any of clauses 1-81, wherein the conversion comprises encoding the current video block into the bitstream.

Clause 83. The method of any of clauses 1-81, wherein the conversion comprises decoding the current video block from the bitstream.

Clause 84. An apparatus for video processing comprising a processor and a non-transitory memory with instructions thereon, wherein the instructions upon execution by the processor, cause the processor to perform a method in accordance with any of clauses 1-83.

Clause 85. A non-transitory computer-readable storage medium storing instructions that cause a processor to perform a method in accordance with any of clauses 1-83.

Clause 86. A non-transitory computer-readable recording medium storing a bitstream of a video which is generated by a method performed by an apparatus for video processing, wherein the method comprises: determining affine information of the current video block based on first affine information of a first block of the video, the first block being coded with a first coding tool different from an affine coding tool; determining a prediction of the current video block based on the affine information; and generating the bitstream based on the prediction.

Clause 87. A method for storing a bitstream of a video, comprising: determining affine information of the current video block based on first affine information of a first block of the video, the first block being coded with a first coding tool different from an affine coding tool; determining a prediction of the current video block based on the affine information; generating the bitstream based on the prediction; and storing the bitstream in a non-transitory computer-readable recording medium.

Clause 88. A non-transitory computer-readable recording medium storing a bitstream of a video which is generated by a method performed by an apparatus for video processing, wherein the method comprises: coding a syntax element related to a combined inter and intra prediction (CIIP) based on more than one context; and generating the bitstream based on the syntax element.

Clause 89. A method for storing a bitstream of a video, comprising: coding a syntax element related to a combined inter and intra prediction (CIIP) based on more than one context; generating the bitstream based on the syntax element; and storing the bitstream in a non-transitory computer-readable recording medium.

### Example Device

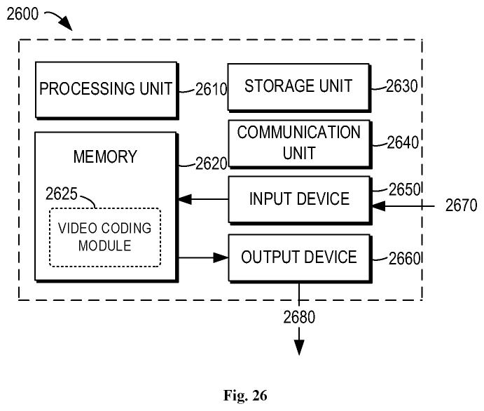

FIG. 26 illustrates a block diagram of a computing device 2600 in which various embodiments of the present disclosure can be implemented. The computing device 2600 may be implemented as or included in the source device 110 (or the video encoder 114 or 200) or the destination device 120 (or the video decoder 124 or 300).

It would be appreciated that the computing device 2600 shown in FIG. 26 is merely for purpose of illustration, without suggesting any limitation to the functions and scopes of the embodiments of the present disclosure in any manner.

As shown in FIG. 26, the computing device 2600 includes a general-purpose computing device 2600. The computing device 2600 may at least comprise one or more processors or processing units 2610, a memory 2620, a storage unit 2630, one or more communication units 2640, one or more input devices 2650, and one or more output devices 2660.

In some embodiments, the computing device 2600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2600 can support any type of interface to a user (such as “wearable” circuitry and the like).

The processing unit 2610 may be a physical or virtual processor and can implement various processes based on programs stored in the memory 2620. In a multi-processor system, multiple processing units execute computer executable instructions in parallel so as to improve the parallel processing capability of the computing device 2600. The processing unit 2610 may also be referred to as a central processing unit (CPU), a microprocessor, a controller or a microcontroller.

The computing device 2600 typically includes various computer storage medium. Such medium can be any medium accessible by the computing device 2600, including, but not limited to, volatile and non-volatile medium, or detachable and non-detachable medium. The memory 2620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2630 may be any detachable or non-detachable medium and may include a machine-readable medium such as a memory, flash memory drive, magnetic disk or another other media, which can be used for storing information and/or data and can be accessed in the computing device 2600.

The computing device 2600 may further include additional detachable/non-detachable, volatile/non-volatile memory medium. Although not shown in FIG. 26, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2640 communicates with a further computing device via the communication medium. In addition, the functions of the components in the computing device 2600 can be implemented by a single computing cluster or multiple computing machines that can communicate via communication connections. Therefore, the computing device 2600 can operate in a networked environment using a logical connection with one or more other servers, networked personal computers (PCs) or further general network nodes.

The input device 2650 may be one or more of a variety of input devices, such as a mouse, keyboard, tracking ball, voice-input device, and the like. The output device 2660 may be one or more of a variety of output devices, such as a display, loudspeaker, printer, and the like. By means of the communication unit 2640, the computing device 2600 can further communicate with one or more external devices (not shown) such as the storage devices and display device, with one or more devices enabling the user to interact with the computing device 2600, or any devices (such as a network card, a modem and the like) enabling the computing device 2600 to communicate with one or more other computing devices, if required. Such communication can be performed via input/output (I/O) interfaces (not shown).

In some embodiments, instead of being integrated in a single device, some or all components of the computing device 2600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2600 may be used to implement video encoding/decoding in embodiments of the present disclosure. The memory 2620 may include one or more video coding modules 2625 having one or more program instructions. These modules are accessible and executable by the processing unit 2610 to perform the functionalities of the various embodiments described herein.

In the example embodiments of performing video encoding, the input device 2650 may receive video data as an input 2670 to be encoded. The video data may be processed, for example, by the video coding module 2625, to generate an encoded bitstream. The encoded bitstream may be provided via the output device 2660 as an output 2680.

In the example embodiments of performing video decoding, the input device 2650 may receive an encoded bitstream as the input 2670. The encoded bitstream may be processed, for example, by the video coding module 2625, to generate decoded video data. The decoded video data may be provided via the output device 2660 as the output 2680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, affine information of the current video block based on first affine information of a first block of the video, the first block being coded with a first coding tool different from an affine coding tool;
determining a prediction of the current video block based on the affine information; and
performing the conversion based on the prediction.

2. The method of claim 1, wherein the first block is coded with at least one of a combined inter and intra prediction (CIIP) mode or a subblock-based CIIP mode, or
wherein the affine information comprises at least one of:
an inter direction,
a control point motion vector (CPMV),
an affine parameter,
at least one reference index of at least one reference picture list,
a local illumination compensation (LIC) flag,
an overlapped block motion compensation (OBMC) flag,
a bi-prediction with coding unit level weights (BCW) index,
an affine type,
a merge type, or
a collocated picture index, or
wherein an affine model comprised in the affine information is utilized by at least one block coded after the first block.

3. The method of claim 2, wherein an affine motion compensation is applied to generate a CIIP prediction of the first block, or
wherein the affine information is used by at least one block coded after the first block, the first block being coded with the subblock-based CIIP.

4. The method of claim 1, wherein the first block is coded with a geometric partitioning mode (GPM).

5. The method of claim 4, wherein an affine motion compensation is applied to generate a GPM prediction of the first block.

6. The method of claim 1, wherein the first block is coded with a multi-hypothesis prediction (MHP) mode.

7. The method of claim 6, wherein an affine motion compensation is applied to generate a MHP prediction of the first block.

8. The method of claim 3, wherein the affine information of the first block is comprised in a history-parameter table (HPT), and
wherein the HPT is updated after at least one of encoding or decoding a subblock-based CIIP coded block.

9. The method of claim 3, wherein the affine information of the first block is included in at least one of an affine merge list or an advanced motion vector prediction (AMVP) candidate list of a block coded after the first block, or
wherein the affine information of the first block is included in an affine candidate list of a second block coded with at least one of the subblock-based CIIP mode or an affine-GPM mode.

10. The method of claim 9, further comprising:
determining to include the affine information in the affine candidate list based on a comparison between the affine information and at least one affine candidate in the affine candidate list, and
wherein in response to that the affine information is the same to the at least one affine candidate in the affine candidate list, the affine information is excluded from the affine candidate list, or
wherein in response to that a difference between the affine information and the at least one affine candidate in the affine candidate list is less than or equal to a threshold, the affine information is excluded from the affine candidate list.

11. The method of claim 1, further comprising:
constructing an affine list based on checking at least one of a sub-block or a block covering a position related to the current video block, and
wherein the affine candidate list comprises at least one of:
a sub-block merge list,
an affine merge list,
an affine AMVP list,
an affine list for GPM, or
an affine list for subblock-based CIIP.

12. The method of claim 11, further comprising:
determining whether the coding tool for the at least one of a sub-block or a block is an affine-based coding tool.

13. The method of claim 12, further comprising:
in accordance with a determination that the coding tool is an affine-based coding tool, using affine information related to the at least one of a sub-block or a block to generate an affine candidate for the affine candidate list.

14. The method of claim 11, further comprising:
determining whether the coding tool for the at least one of a sub-block or a block is at least one of an GPM-affine-based coding tool or a subblock-based CIIP coding tool.

15. The method of claim 14, further comprising:
in accordance with a determination that the coding tool is at least one of an GPM-affine-based coding tool or a subblock-based CIIP coding tool, using affine information related to the at least one of a sub-block or a block to generate an affine candidate for the affine candidate list, and
wherein the at least one of a sub-block or a block is checked to generate the affine candidate from a subblock-based CIIP coded block.

16. The method of claim 15, wherein after checking an inherited affine candidate from a block which is adjacent to the current block, the at least one of a sub-block or a block is checked to generate the affine candidate from the subblock-based CIIP coded block immediately, or
wherein after checking an inherited affine candidate from a block which is non-adjacent to the current block, the at least one of a sub-block or a block is checked to generate the affine candidate from the subblock-based CIIP coded block immediately, or
wherein after checking a regression-based motion vector field (RMVF) affine candidate, the at least one of a sub-block or a block is checked to generate the affine candidate from the subblock-based CIIP coded block immediately, or
wherein after checking a constructed affine candidate, the at least one of a sub-block or a block is checked to generate the affine candidate from the subblock-based CIIP coded block immediately, or
wherein after checking a temporal inherited affine candidate, the at least one of a sub-block or a block is checked to generate the affine candidate from the subblock-based CIIP coded block immediately, or
wherein after checking a history-based affine candidate, the at least one of a sub-block or a block is checked to generate the affine candidate from the subblock-based CIIP coded block immediately.

17. The method of claim 1, wherein the conversion comprises: generating the bitstream from the video, and
the method further comprises: storing the bitstream in a non-transitory computer-readable recording medium.

18. The method of claim 1, wherein the conversion comprises encoding the current video block into the bitstream, or
wherein the conversion comprises decoding the current video block from the bitstream.

19. An apparatus for video processing comprising a processor and a non-transitory memory with instructions thereon, wherein the instructions upon execution by the processor, cause the processor to perform operations comprising:
determining, for a conversion between a current video block of a video and a bitstream of the video, affine information of the current video block based on first affine information of a first block of the video, the first block being coded with a first coding tool different from an affine coding tool;
determining a prediction of the current video block based on the affine information; and
performing the conversion based on the prediction.

20. A non-transitory computer-readable storage medium storing instructions that cause a processor to perform operations comprising:
determining, for a conversion between a current video block of a video and a bitstream of the video, affine information of the current video block based on first affine information of a first block of the video, the first block being coded with a first coding tool different from an affine coding tool;
determining a prediction of the current video block based on the affine information; and
performing the conversion based on the prediction.
